(19) United States
(12) Patent Application Publication
(10) Pub. No.: US 2024/0119470 A1
(43) Pub. Date: Apr. 11, 2024

(54) SYSTEMS AND METHODS FOR GENERATING A FORECAST OF A TIMESERIES

(71) Applicant: Panasonic Intellectual Property Management Co., Ltd., Osaka (JP)

(72) Inventors: Debdeep PAUL, Singapore (SG); Chandra Suwandi Wijaya, Singapore (SG); Yizhou Huang, Singapore (SG); Khai Jun Kek, Singapore (SG); Koji Miura, Osaka (JP)

(21) Appl. No.: 17/955,053

(22) Filed: Sep. 28, 2022

(51) Int. Cl. G06Q 30/02

(52) U.S. Cl. CPC G06Q 30/0202

(57) ABSTRACT

According to an embodiment, a method for generating a forecast of a timeseries is disclosed. The method comprises receiving a set of features comprising data and timeseries to be used by each of a plurality of prediction models for generating the forecast. Further, the method comprises generating using the set of features, a plurality of forecast results based on an ensemble of the plurality of prediction models. Furthermore, the method comprises optimizing the plurality of forecast results associated with a respective forecast module. Additionally, the method comprises probabilistically combining the outputs of the plurality of optimization modules. Moreover, the method comprises outputting a final forecast based on the combination of the at least two forecast results.

### FIELD OF THE INVENTION

The present invention generally relates to generating forecasts, and more particularly relates to systems and methods for generating forecast of a timeseries.

### BACKGROUND

As is appreciated by those familiar with the art, a lack of study in demand and supply in a particular business may prove costly to business owners in today's competitive market. The discrepancy of demand and supply may result in missing potential sales opportunities, decreased revenue, excessive operational costs, shrinking profits, and poor customer service. To maximize sales and marketing effectiveness, business owners must accurately predict future customer demand and use this information to drive their business operations from manufacturing to operations to distribution.

In the process of prediction such as, forecasting demand, sales or revenues, business owners generate the forecast in raw numbers input or otherwise provided from various users working for the business owner as employees. This process is typically carried out on a periodic basis. Thus, to support the production planning and inventory management, the issue of demand forecasting is significantly critical to the business of an organization. Especially, for a complex supply chain with multiple markets and hundreds of thousands of products, the task of demand forecasting becomes quite challenging.

Todays' modern factories are accelerating digital transformation in the business, and its operation, by leveraging Artificial Intelligence (AI) and Big Data techniques to optimize business performance and maximize return on investment. Thus, with the advent of advanced machine learning based predictive analytics tools and techniques, the process of demand forecasting is increasingly getting automated rather than manual. Machine learning and big data techniques have been widely adopted in factory predictive analysis to improve manufacturing OEE and ISP management. Whereas machine learning model often faces big challenges to perform if the target variable (quantity to be forecasted) shows very high fluctuation. This also exacerbate the issue of data drift, where the distribution of data varies significantly varies between the training and forecasting set.

The above problem makes the traditional ML solutions largely ineffective and erroneous. Besides, many problems in factory features hierarchy in nature. For example, a production line is composed of a number of sequential processes, and each process have many machines. For such hierarchy system, it is critical to conduct collaborative (grouping) analysis and prediction to enhance overall system performance as compared to simple sum of individual prediction models.

In applications such as OEE, ISP, the issue of covariance shift is severe, i.e., shifting of statistical relationship between input features and the target from seen and unseen data due to nonlinear dynamics of manufacturing machines, process, systems, and business environment. This results in prediction with low accuracy and robustness.

There is a need for a solution that determines generation of forecast with model controllability and thus generate highly explainable and robust forecast models.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

According to an embodiment of the present disclosure, a system for generating a forecast of a timeseries is disclosed. The system comprises an input module configured to receive a set of features comprising data and timeseries to be used by each of a plurality of prediction models for generating the forecast. Further, the system comprises a plurality of arbitrary forecast modules, wherein each arbitrary forecast module is configured to generate, using the set of features, a plurality of forecast results based on an ensemble of the plurality of prediction models associated with two or more families of models. Furthermore, the system comprises a plurality of optimization modules, each optimization module being configured to optimize the plurality of forecast results associated with a respective forecast module among the plurality of forecast modules, wherein each optimization module is further configured to optimize the plurality of forecast results by minimizing a validation error of an aggregated forecast derived using a plurality of optimization metrices subjected to physical and operational constraints. Additionally, the system comprises a forecast result combination module configured to probabilistically combine the outputs of the plurality of optimization modules. Moreover, the system comprises an output module that outputs a final forecast based on the combination of the at least two forecast results.

According to another embodiment of the present disclosure, a method for generating a forecast of a timeseries is disclosed. The method comprises receiving, by an input module, a set of features comprising data and timeseries to be used by each of a plurality of prediction models for generating the forecast. Further, the method comprises generating, by each arbitrary forecast module among a plurality of arbitrary forecast modules, using the set of features, a plurality of forecast results based on an ensemble of the plurality of prediction models. Furthermore, the method comprises optimizing, by each optimization module among a plurality of optimization modules, the plurality of forecast results associated with a respective forecast module, wherein the optimization is performed on the plurality of forecast results by minimizing a validation error of an aggregated forecast derived using a plurality of optimization metrices subjected to physical and operational constraints. Additionally, the method comprises probabilistically combining, by a forecast result combination module, the outputs of the plurality of optimization modules. Moreover, the method comprises outputting, by an output module, a final forecast based on the combination of the at least two forecast results.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram of a system 100 for forecasting a fluctuating time series, according to an embodiment of the present disclosure;

FIG. 2 illustrates a detailed view of the modules 106 within a schematic block diagram of a system 100 for forecasting a fluctuating time series, according to an embodiment of the present disclosure;

FIG. 3 illustrates an exemplary process flow comprising a method 300 for generating a forecast of a timeseries, according to an embodiment of the present disclosure;

FIGS. 4A and 4B illustrate another exemplary process flow comprising a method 400a and a graphical user interface (GUI) 400b respectively for generating a forecast of a timeseries, according to an embodiment of the present disclosure;

FIG. 5 illustrates another exemplary block diagram depicting a process flow for generating a forecast of a timeseries, according to an embodiment of the present disclosure;

FIG. 6 illustrates an exemplary model ensembling and optimization at forecast and optimization modules respectively for generating a forecast, according to an embodiment of the present disclosure;

FIGS. 7A and 7B illustrate another process flow for generating forecast for an input data, according to an embodiment of the present disclosure;

FIG. 8 illustrates hierarchical ensembling and customized optimization (HECO) in forecast modules and optimization modules based on integrating multiple (ensembling) models with different optimization strategies, according to an embodiment of the present disclosure; and

FIG. 9 illustrates a forecast result combination module to combine the forecasts generated by different HECO modules (i.e., forecast and optimization modules) through a probabilistic approach, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure proposes a Hierarchical Ensembling and Customized Optimization (HECO) model architecture to address the issues in forecasting highly fluctuating timeseries and the data drift or covariance shift associated with it as described above.

The present invention is directed towards a method and system for generating a forecast for a timeseries and based on input data. In the system, different sets of features from the input data, are fed to different family of models and an arbitrary number of forecasts are generated for each point. Thereafter, these forecasts are combined through the customized optimization procedure to generate the final forecast.

According to various embodiments of the present disclosure, a forecasting methodology to address the issue of predicting dramatically fluctuating demand for some of the products.

Conventionally, it is observed that the forecast generated by a single machine learning model is very different from the one generated by another model in such scenario. In fact, for a single model, there is a huge difference among the forecasts generated with different hyper parameters. Therefore, the present disclosure is directed towards utilizing a large number of predictive machine learning models, generating a distribution of forecasts, and combining these forecasts based on a unique optimization framework and probabilistic combination.

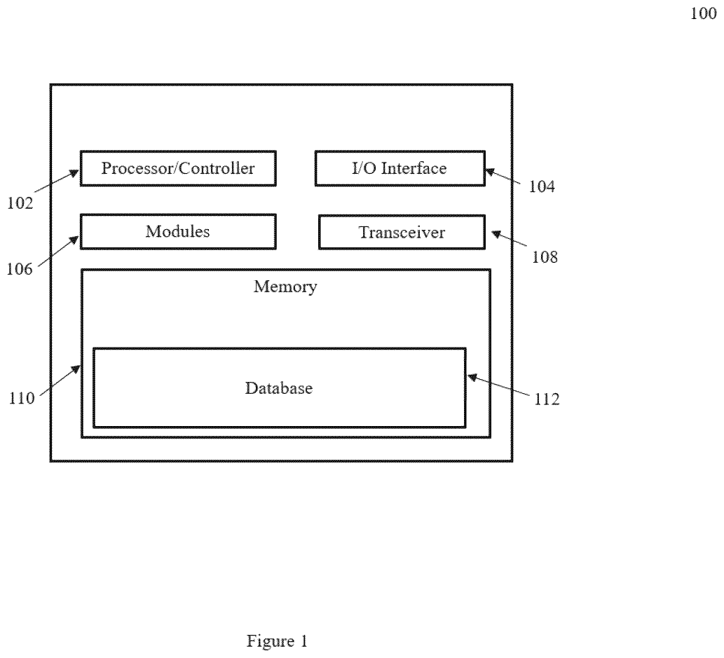

FIG. 1 illustrates a schematic block diagram of a system 100 for forecasting a fluctuating time series, according to an embodiment of the present invention. In one embodiment, the system 100 may be used to implement the methods for forecasting of timeseries, as discussed hereinafter.

In one embodiment, the system 100 may be included within a mobile device or a server. Examples of mobile device may include, but not limited to, a laptop, smart phone, a tablet, or any electronic device having a capability to access internet and to install a software application(s). The system 100 may further include a processor/controller 102, an I/O interface 104, modules 106, transceiver 108, and a memory 110.

In some embodiments, the memory 110 may be communicatively coupled to the at least one processor/controller 102. The memory 110 may be configured to store data, instructions executable by the at least one processor/controller 102. In some embodiments, the modules 106 may be included within the memory 110. The memory 110 may further include a database 112 to store data. The one or more modules 106 may include a set of instructions that may be executed to cause the system 100 to perform any one or more of the methods disclosed herein. The one or more modules 106 may be configured to perform the steps of the present disclosure using the data stored in the database 112, to perform forecasting of a fluctuating timeseries, as discussed throughout this disclosure. In an embodiment, each of the one or more modules 106 may be a hardware unit which may be outside the memory 110. The transceiver 108 may be capable of receiving and transmitting signals to and from system 100. The I/O interface 104 may include a display interface configured to receive user inputs and display output of the system 100 for the user(s). Specifically, the I/O interface 104 may provide a display function and one or more physical buttons on the system 100 to input/output various functions, as discussed herein. Other forms of input/output such as by voice, gesture, signals, etc. are well within the scope of the present invention. For the sake of brevity, the architecture and standard operations of memory 110, database 112, processor/controller 102, transceiver 108, and I/O interface 104 are not discussed in detail. In one embodiment, the database 112 may be configured to store the information as required by the one or more modules 106 and processor/controller 102 to perform one or more functions to forecast a fluctuating timeseries.

In one embodiment, the memory 110 may communicate via a bus within the system 100. The memory 110 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 110 may include a cache or random-access memory for the processor/controller 102. In alternative examples, the memory 110 is separate from the processor/controller 102, such as a cache memory of a processor, the system memory, or other memory. The memory 110 may be an external storage device or database for storing data. The memory 110 may be operable to store instructions executable by the processor/controller 102. The functions, acts or tasks illustrated in the figures or described may be performed by the programmed processor/controller 102 for executing the instructions stored in the memory 110. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

Further, the present invention contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor/controller 102 or maybe a separate component. The communication port may be created in software or maybe a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 100 may be physical or may be established wirelessly. The network may alternatively be directly connected to the bus.

In one embodiment, the processor/controller 102 may include at least one data processor for executing processes in Virtual Storage Area Network. The processor/controller 102 may include specialized processing units such as, integrated system (bus) controllers, memory management control units, floating point units, graphics processing units, digital signal processing units, etc. In one embodiment, the processor/controller 102 may include a central processing unit (CPU), a graphics processing unit (GPU), or both. The processor/controller 102 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 102 may implement a software program, such as code generated manually (i.e., programmed).

The processor/controller 102 may be disposed in communication with one or more input/output (I/O) devices via the I/O interface 104. The I/O interface 104 may employ communication code-division multiple access (CDMA), high-speed packet access (HSPA+), global system for mobile communications (GSM), long-term evolution (LTE), WiMax, or the like, etc.

The processor/controller 102 may be disposed in communication with a communication network via a network interface. The network interface may be the I/O interface 104. The network interface may connect to a communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

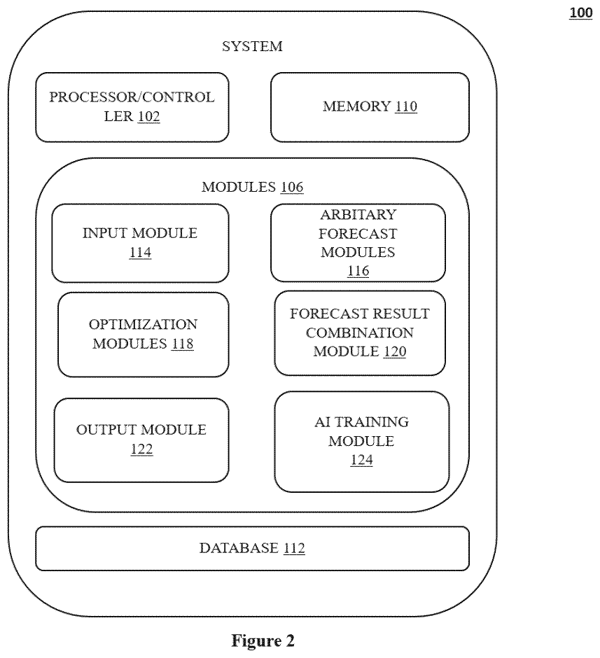

FIG. 2 illustrates a detailed view of the modules 106 within a schematic block diagram of a system 100 for forecasting a fluctuating time series, according to an embodiment of the present disclosure. As illustrated, in one embodiment, the one or more modules 106 may include an input module 114, a plurality of arbitrary forecast modules 116, a plurality of optimization modules 118, a forecast result combination module 120, and an artificial intelligence (AI) training module 122.

In one embodiment, an input module 114 may be configured to receive a set of features comprising data and a target timeseries to be used by each of a plurality of prediction models for generating the forecast. The set of features may include, but not limited to, macroeconomic indices, automotive market indices, stock price of relevant companies, etc.

Further, the input module 114 may be configured to receive an input associated with a number of the plurality of forecast modules. For example, 2-4 forecast modules may be selected for forecast of a timeseries. Additionally, the input module 114 may be configured to receive one or more inputs associated with the selection of the plurality of prediction models and a plurality of hyperparameters for each forecast module. The plurality of prediction machine learning models or family models may include, but not limited to, linear models, non-linear models, tree-based models, gradient boost, random forest, neural network (along with number of layers), etc. Each model may generate a number of best results by means of hypermeters tuning as well as feature engineering approaches with different mathematical assumptions. In machine learning, a specific model has a range of parameters known as hyperparameters. The process of selecting the optimal combination of these parameters in known as hyperparameters tuning. On the other hand, among the different measurable properties of input datasets or features, the process of selecting a subset of such features (based on information content, correlation and other metrices) is known as feature selection.

For prediction of dramatically fluctuating time series, where the variation in the predicted (target) variable is orders of magnitude higher than that in the features, individual models are very fragile due to issues, such as covariance shift (data drift). Also, in general, one single result is produced by each model with traditional approach, which is not reliable and stable under short-term and high fluctuating time series scenarios. An ensembling approach based on different family of models with each model producing multiple results instead of a single one, tends to significantly enhance forecast robustness to address the issues.

Further, the input module 114 is further configured to receive an input associated with an arbitrary filtering criterion to filter the plurality of forecast results based on one or more statistical functions. Specifically, the input module 114 may receive inputs for selecting the logic for filtering a controlled proportion of forecasts. In an exemplary embodiment, the filtering criterion may include selecting forecasts (of models) with MAPE<threshold.

In an embodiment, each of the plurality of arbitrary forecast modules 116 may be configured to generate, using the set of features, a plurality of forecast results based on an ensemble of the plurality of prediction machine learning models associated with two or more families of models. Specifically, the forecast is being generated by multiple layers, which is described here as hierarchical ensembling.

In one embodiment, each of the plurality of optimization modules 118 may be configured to optimize the plurality of forecast results associated with a respective forecast module among the plurality of forecast modules, wherein each optimization module is further configured to optimize the plurality of forecast results by minimizing a validation error of an aggregated forecast derived using a plurality of optimization metrices subjected to physical and operational constraints. Such physical constraints may include, the optimal weights (used to compute a single forecast from the forecasts generated using a plurality of models) as computed by the optimization problem, and should only include non-negative values non-compliance to which may result in negative forecast which may be physically meaningless. Another example could be the sum of the weights up to one. Otherwise, the forecast value may be arbitrarily high and may result in very low accuracy. In some cases, the upper bound or the lower bound of the forecast may be given by the user. In an exemplary embodiment, in case of demand prediction, there may be some contractual agreement between a supplier and a buyer that there will be some minimum and maximum order for each pre-negotiated timeframe, which can be an operational constraint. Some other examples of operational constraints can be, the transportation network may have certain bottlenecks due to which the order should be less than the maximum capacity, or there can be regulations. The present invention takes into consideration all such constraints.

A hierarchical ensembling model architecture is designed to integrate multiple models which implement different optimization methods, as illustrated, to enhance overall model performance in terms of accuracy and robustness. The plurality of optimization modules 118 may be configured to combine the forecasts generated through an arbitrarily large number of machine learning models (with different set of features and a wide range of hyperparameters). Further, the plurality of optimization modules 118 is configured to minimize the validation error (or any user defined function of validation errors thereof) of the aggregated forecast.

Existing approaches combine multiple forecasts only based on one single optimization metrics such as MAPE. The present disclosure provides a mechanism to combine forecasts such as to minimize any arbitrary function of MAPE, variance, max error, error at certain points etc. This addresses distribution drift issue as well as challenges from limited (short-term) dataset and high fluctuation.

In one embodiment, a forecast result combination module 120 may be configured to probabilistically combine the outputs of the plurality of optimization modules. The forecast result combination module 120 is configured to combine forecasts generated through different HECO modules that results from different sets of features, different families of forecast models, different optimization procedures to combine them. The forecast result combination module 120 includes a family of statistical methods to combine multiple forecasts of the same time series together.

In one embodiment, an output module 122 may be configured to output a final forecast based on the combination of the at least two forecast results. The final forecast may be output on a graphical/display user interface associated with the system 100.

In one embodiment, the AI training module 124 may include a plurality of neural network layers. Each layer has a plurality of weight values and performs a neural network layer operation through calculation between a result of computation of a previous layer and an operation of a plurality of weights. In particular, the AI training module 124 may include AI models that are used by the controller 102 for forecast of a timeseries. The AI models may include, but are not limited to, Ensemble models, support vector machines (SVM) based models, and neural network (NN) models including at least one of wide neural network (WNN) model, bilayer neural network (BNN) model, and medium neural network model.

Further, the AI training module 124 is configured to train AI models of the 116-120 based on the instructions under the control of the controller 102. In an embodiment, there are various computations involved in the training process of the AI training module 124. Here, “training” means that a predefined operation rule or artificial intelligence model configured to perform the desired feature (or purpose) is obtained by training a basic artificial intelligence model with multiple pieces of training data by a training technique. The learning may be performed in the system itself in which AI according to an embodiment is performed, and/or may be implemented through a separate server/system.

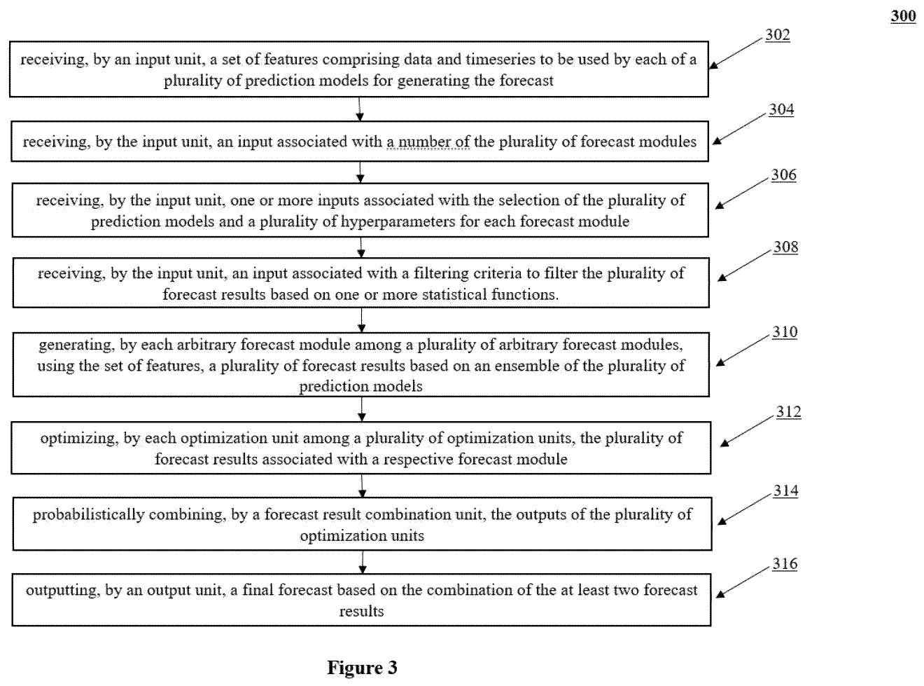

FIG. 3 illustrates an exemplary process flow comprising a method 300 for generating a forecast of a timeseries, according to an embodiment of the present disclosure. For the sake of brevity, details of the present disclosure that are explained in detail in the description of FIG. 1 and FIG. 2 are not explained in detail in the description of FIG. 3.

At step 302, the method 300 comprises receiving, by an input module, a set of features comprising data and timeseries to be used by each of a plurality of prediction models for generating the forecast. The set of features may include input data, such as market index. Further, different sets of features are fed to different family of models and an arbitrary number of forecasts are generated for each point, as described hereinafter.

At step 304, the method 300 comprises receiving, by the input module, an input associated with a number of the plurality of forecast modules. Each forecast module among the plurality of forecast modules may comprise an independent ensemble learning model that combines the plurality of prediction models, and wherein each forecast module is independently configurable.

At step 306, the method 300 comprises receiving, by the input module, one or more inputs associated with the selection of the plurality of prediction machine learning models and a plurality of hyperparameters for each forecast module. In one embodiment, the plurality of prediction machine learning models may include two or more of a linear regression model, a support vector regression model, a ridge regression model, a lasso regression model, an elastic net model, a Bayesian ridge model, a huber regression model, a KNN model, a gradient boost model, a random forest regression model, and a neural network including deep architectures with a range of hyperparameters.

At step 308, the method 300 comprises receiving, by the input module, an input associated with a filtering criterion to filter the plurality of forecast results based on one or more statistical functions.

At step 310, the method 300 comprises generating, by each arbitrary forecast module among a plurality of arbitrary forecast modules, using the set of features, a plurality of forecast results based on an ensemble of the plurality of prediction machine learning models.

At step 312, the method 300 comprises optimizing, by each optimization module among a plurality of optimization modules, the plurality of forecast results associated with a respective forecast module. Each optimization module has an independent optimization method for each forecast module. The optimization may be performed on the plurality of forecast results by minimizing a validation error of an aggregated forecast derived using a plurality of optimization metrices subjected to physical and operational constraints. In one embodiment, the plurality of optimization metrics may be based on Mean Absolute Percentage Error (MAPE), Mean Absolute Error (MAE), variance, maximum error, and one or more user configurable parameters to combine the forecasts generated by each prediction model within the same forecast module.

At step 314, the method 300 comprises probabilistically combining, by a forecast result combination module, the outputs of the plurality of optimization modules. The forecast result combination module may be configured to use a user-defined statistical method.

At step 316, the method 300 comprises outputting, by an output module, a final forecast based on the combination of the at least two forecast results. In one embodiment, an output interface or a graphical user interface (GUI) or a display interface may be configured to display the final forecast output.

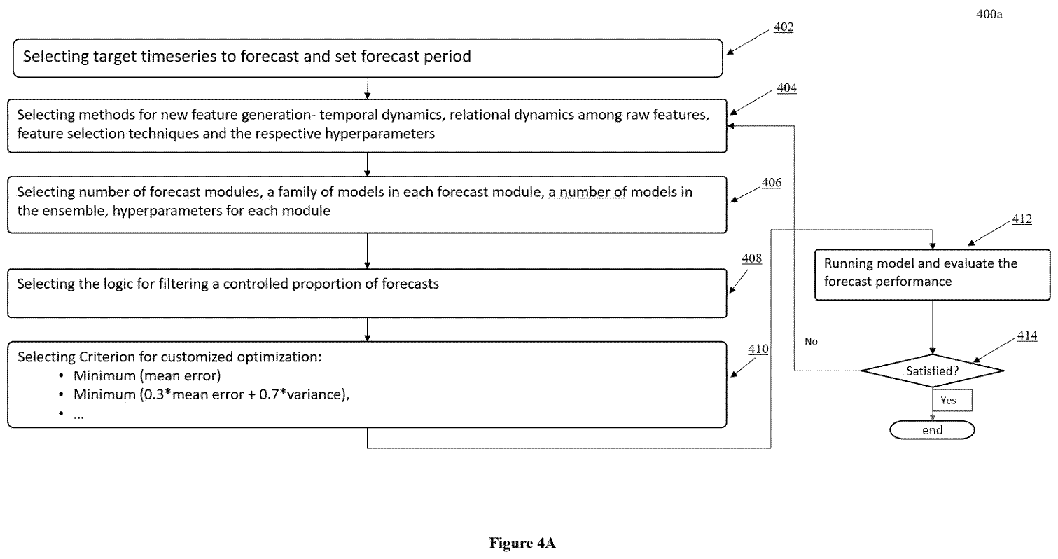

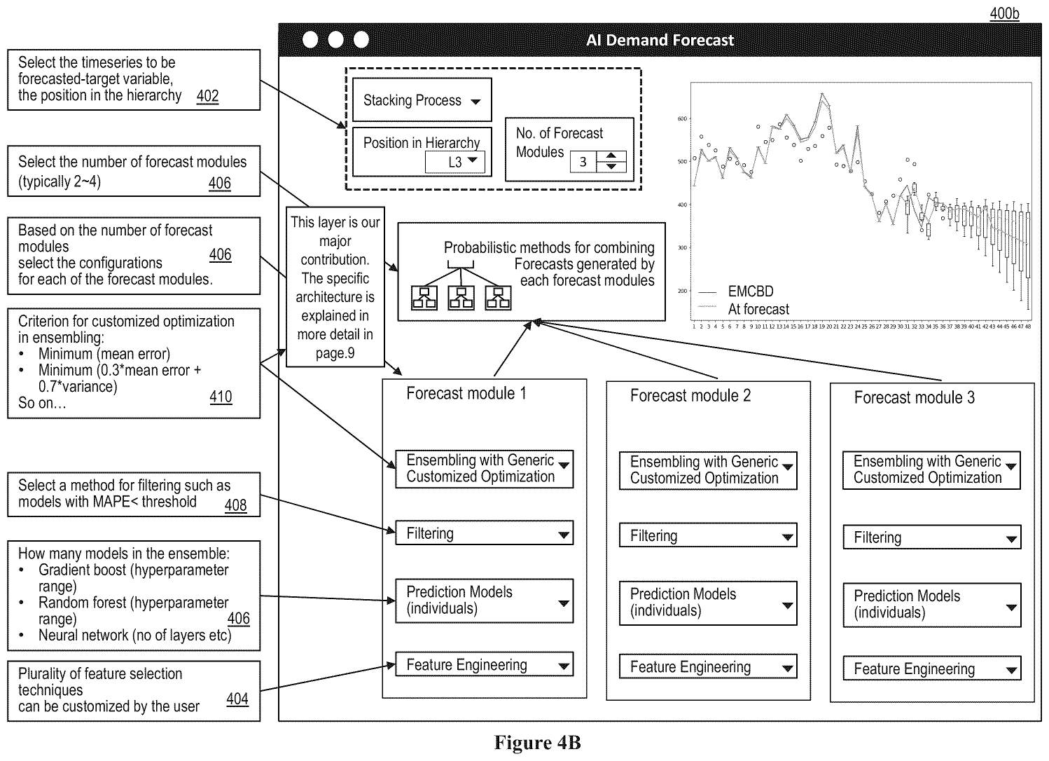

FIGS. 4A and 4B illustrate another exemplary process flow comprising a method 400a and a graphical user interface (GUI) 400b respectively for generating a forecast of a timeseries, according to an embodiment of the present disclosure.

At step 402, the method 400a comprises selecting target timeseries to forecast and setting forecast period.

At step 404, the method 400a comprises selecting methods for new feature generation-temporal dynamics, relational dynamics among raw features, feature selection techniques and the respective hyperparameters.

At step 406, the method 400a comprises selecting a number of forecast modules (typically 2-4), selecting the family of models in each forecast module, a number of models, a number of the family of models in each forecast module, and hyperparameters in each module. The models may include, for example, but not limited to, gradient boost (with arbitrary hyperparameter range), random forest (with arbitrary hyperparameter range), neural network (arbitrary architecture, number of layers).

At step 408, the method 400a comprises selecting the logic for filtering a controlled proportion of forecasts. By default, there are some criterion for selection and may further be customized by the user.

At step 410, the method 400a comprises selecting criterion for customized optimization. For example, the criterion may include minimum (mean error), minimum (0.3*mean error+0.7*variance+0.4*maximum error), among all the validation points, etc.

At step 412, the method 400a comprises running the model and evaluating the forecast performance.

At step 414, the method 400a comprises determining whether the results are satisfactory. If the results are satisfactory, the process flow moves to end, otherwise the process flow moves to step 404. In one embodiment, the performance metrices associated with the results may be dynamically designed by the user and may be agnostic to the workflow on a case-to-case basis. The forecast accuracy may be judged based on MAPE, MAE, etc. on the forecast periods that is unseen by the model. If the MAPE, MAE, or any other metrices defined by the user exceeds the requirement (i.e., if the results are unsatisfactory), then the user may choose to repeat this with a different configuration.

While the above steps are shown in FIGS. 3 and 4 and described in a particular sequence, the steps may occur in variations to the sequence in accordance with various embodiments of the present disclosure. Further, the details related to various steps of FIGS. 3 and 4, which are already covered in the description related to FIGS. 1-2 are not discussed again in detail here for the sake of brevity.

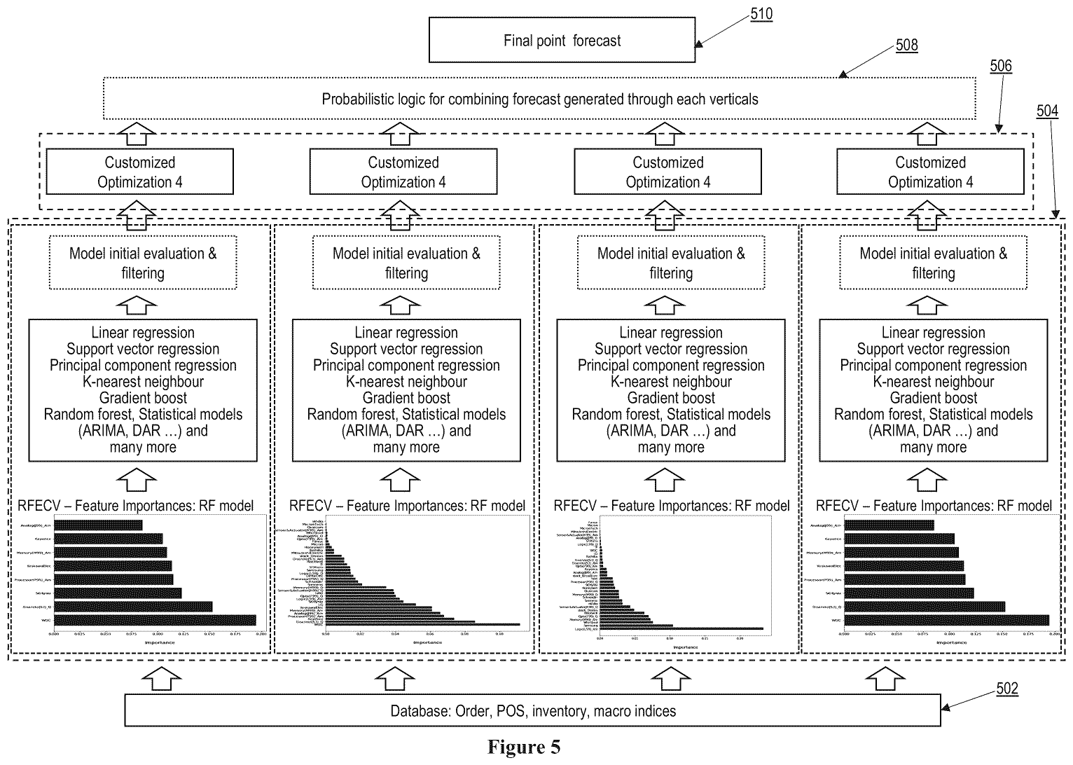

FIG. 5 illustrates another exemplary block diagram depicting a process flow for generating a forecast of a timeseries, according to an embodiment of the present disclosure.

As depicted, order, POS, inventory, macro indices are fed as input features from the database at step 502. Specifically, at the bottom of this architecture, there is a database that includes the auxiliary data such as stock price, macroeconomic indices, automotive market indices that are used as features to the machine learning models to generate the forecast. As illustrated, in this example, four forecast modules are selected as per input provided by a user. Further, at step 504, one or more machine learning models are selected for each of the forecast modules. The one or more machine learning models may include linear regression, support vector regression, principal component regression, K-nearest neighbour, Gradient boost, random forest, statistical models (ARIMA, DAR), etc. Additionally, at step 504, model initial evaluation and filtering (through any function of errors at different validation point) is performed on the outcome of the models inside each forecast modules. The criterion for initial evaluation may be different from the objective function of the optimization modules in the upstream of the workflow.

At step 506, a customized optimization is implemented for each outcome of a forecast module. At step 508, the forecasts generated through each verticals are combined probabilistically to provide a final point forecast as an output at step 510.

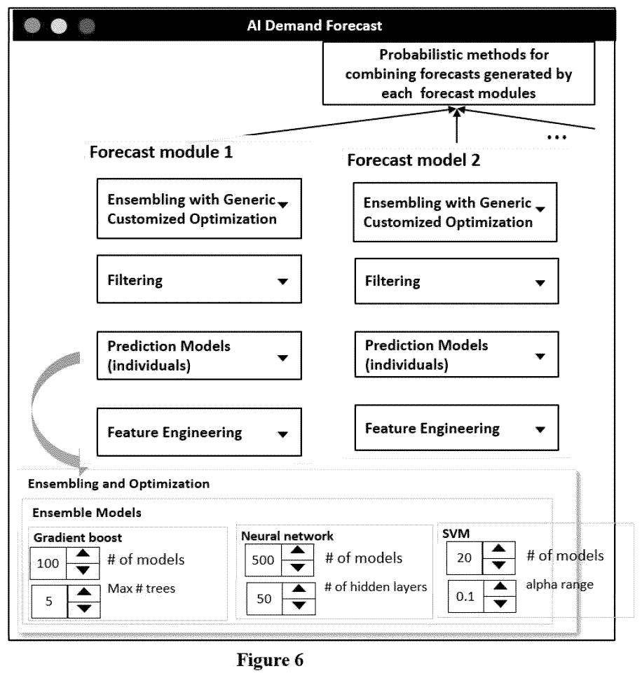

FIG. 6 illustrates an exemplary model ensembling and optimization at forecast and optimization modules respectively for generating a forecast, according to an embodiment of the present disclosure. As illustrated, the GUI may provide options to select/customize features, prediction models, filtering criteria, and optimizations. For example, a number of forecast modules, number of models within each forecast module, may be selected/customized. As illustrated in FIG. 6, models ensembling may be performed by selecting number of models for gradient boost along with hyper parameters such as maximum number of trees. Similarly, a number of models within a neural network along with hyperparameters related to number of hidden layers within the neural network. Also, a number of SVM models may be selected by the user along with hyperparameters related to the range of alpha.

In the depicted model ensembling approach of FIG. 6, different family of models may be employed, each model may produce a number of forecast results, all model results pass a filter, and then perform model ensembling. The depicted hierarchical ensembling model architecture is configured to integrate multiple models which implement different family of forecasting approaches with each model generating multiple results. This helps to enhance the quality of the final forecast in terms of robustness, sensitivity, stability and accuracy. This addresses the issue of high fluctuation in the target variable. In the hierarchical structure, the fluctuation in the timeseries increases dramatically higher as the hierarchy goes lower.

For the prediction of a dramatically fluctuating time series where the variation in the variable to be predicted is orders of magnitude higher than that of the features, the forecast produced by the individual models are very fragile. The combination of a large number of methods based on different models with different mathematical assumptions tend to significantly enhance the robustness of the forecast by addressing the issue of covariance shift (data drift).

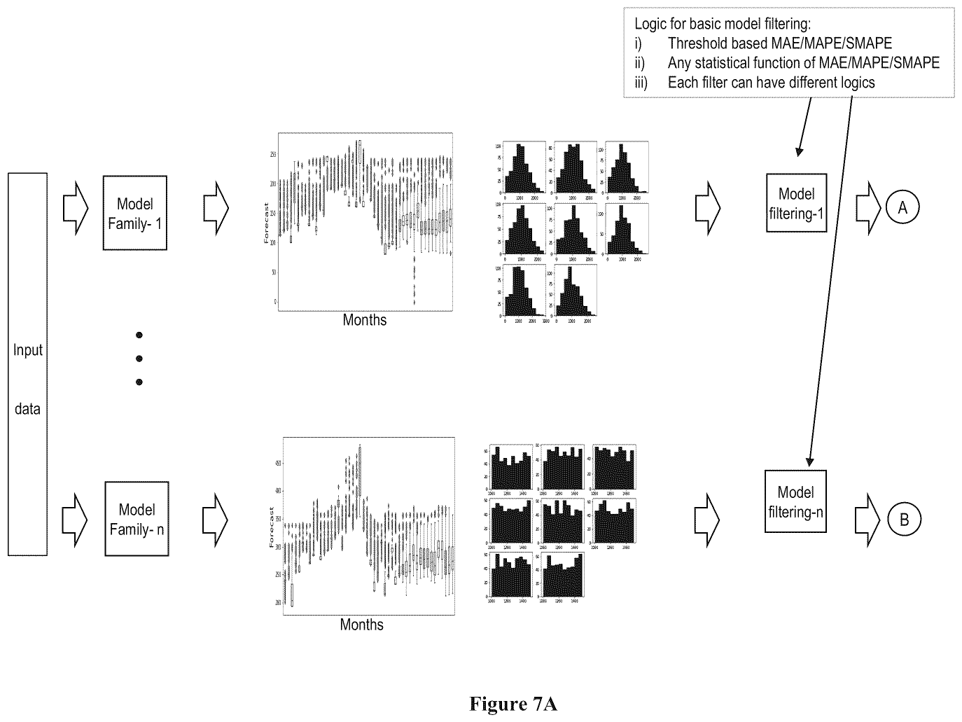

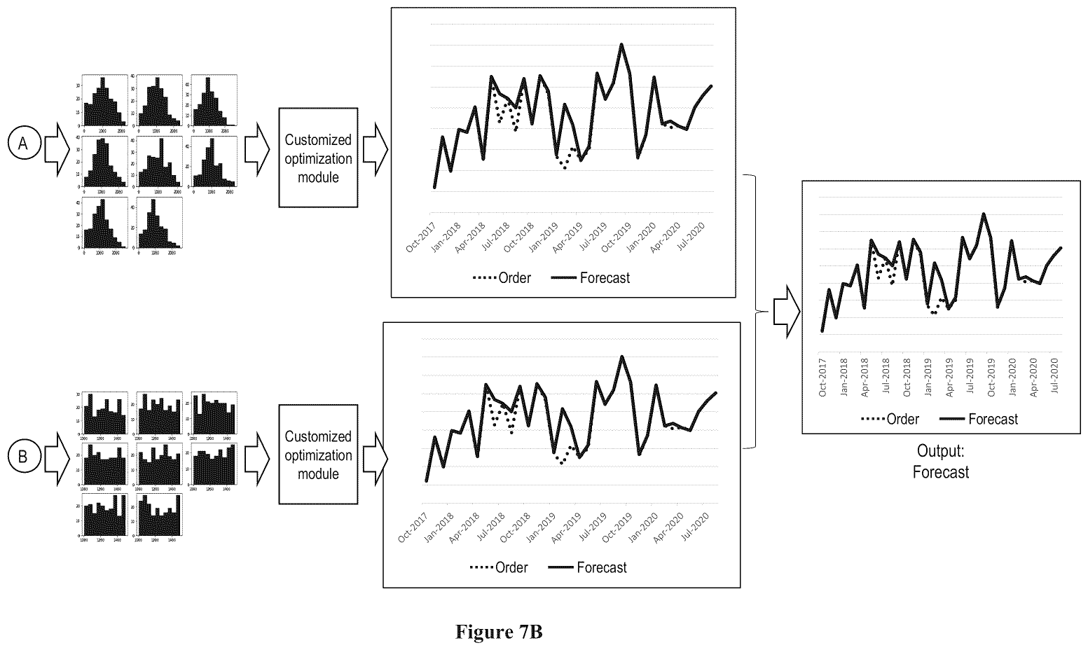

In the forecast modules, different family of forecast models such as linear, tree based, neural network, etc. are combined in a unique way. The different family of models has different statistical assumptions about the distribution of the target variable and the features. Based on the actual distribution of the data, performance of different forecast models are different and that is not known ahead of time. In the present disclosure, many model families are combined together arbitrarily through an optimization procedure, as depicted in FIGS. 7A and 7B.

In contrast, in conventional approaches, as we go down along the hierarchy for finer timeseries, the fluctuation is very high, different family of models produce forecast that is very different from each other. In other words, the variance between the forecast generated by different models (or in a single model with different hyperparameter setting) is very high. In this case depending on a single model may make the forecast very unstable and sensitive to input data. A very little noise or inaccuracy can dramatically increase the forecast error. Such issues are overcome using the model ensembling and optimization approach disclosed herein.

FIGS. 7A and 7B illustrate another process flow for generating forecast for an input data, according to an embodiment of the present disclosure. As illustrated, various family of models are included for processing input data and generating a forecast for a target variable. Further, model outputs are filtered according to various exemplary logics. For example, threshold based MAE/MAPE/SMAPE, any statistical function of MAE/MAPE/SMAPE, etc. may be used to implement basic model filtering.

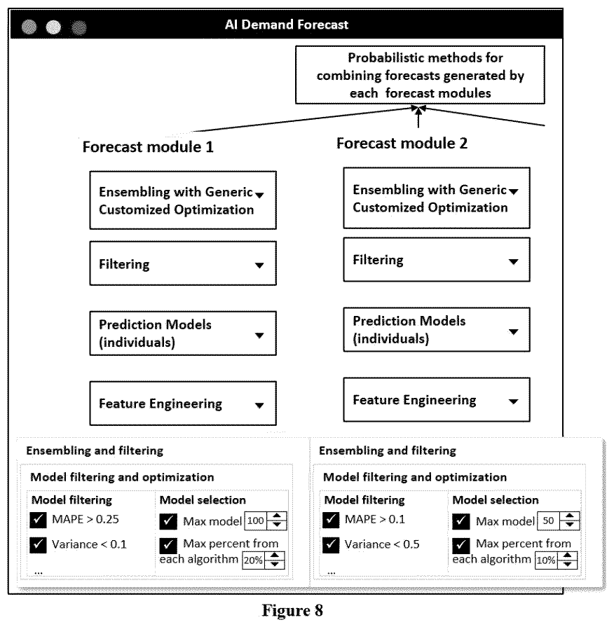

FIG. 8 illustrates hierarchical ensembling and customized optimization (HECO) in forecast modules and optimization modules based on integrating multiple (ensembling) models with different optimization strategies, according to an embodiment of the present disclosure.

As illustrated, a hierarchical ensembling model architecture is designed to integrate multiple models which implement different optimization methods to enhance overall model performance in terms of accuracy and robustness. This addresses challenges from limited (short-term) dataset and high fluctuation such as high risk and data drift.

As illustrated, a user may assign a number of forecast models on the GUI to run HECO, and each forecast model may deploy different ensembling and customized optimization approaches. For example, model 1 may optimize MAPE, while model 2 may optimize α*mean error+β*variance, where α, β is configurable by the user, and model 3 may optimize α more customizable performance metric function f(MAPE, Variance, maximum error, higher moment . . . ) where the user may design any objective function and the constraints (physical, operational) Based on the application, these constraints may be different. For example, in case of a demand forecasting, the optimal weights should sum to one and be non-negative. If they don't sum to one, then the resulting forecast can be arbitrarily large or small if there is no lower bound on the sum. Additionally, there may exist a contractual agreement between parties deploying the forecasting model to ensure that the order will be between certain ranges. An example of an operational constraint is for a network of supply, then the order must respect the path limits. A physical constraint can be the following. For example, in a factory shopfloor application, there may be some physical characteristic of the system such as there may be some upper and lower bound in the current through a circuit and so on. In general, for any application, there may be such requirements. These can appropriately be enforced by encoding them through the weights computed through the optimization and probabilistic ensembling modules.

HECO may integrate multiple models from different optimization strategies and approaches to enhance model short-term accuracy and long-term robustness to address challenges of short-term (limited) data size and high fluctuation data.

Multiple model results may be selected from each AI model generated with different hyperparameters. For example, in random forecast model, the system searches multiple hyperparameters, such as node size, number of trees, maximum number of terminal nodes trees in the forest.

The objective of the forecast aggregation via plurality of optimization modules is to combine the forecasts generated by the N models in the ensemble to create a final point forecast with low validation error. To achieve this, an exemplary scalable optimization-based framework is presented below. A weighted average-based methodology for the forecast aggregation may be employed, where the respective weights are computed based on this optimization framework.

The validation error in point i is given by:

$$ε ( i , j ) = \frac{100 \times ( {d}_{j} - {y}_{j}^{i} )}{{d}_{j}} , for j in validation period . \qquad ( 1 )$$

Now α∈ [symbol] ^{N} is the weight vector that is multiplied with the forecast ensemble matrix Y to generate the final forecast ŷ. In a typical scenario, in the forecast ensemble, some forecasts will be more than the actual demand and some will be less than the actual demand That implies, at validation point j, ε(i, j)>0 for some i, and ε(i, j)≤0 for others. The present embodiment of the disclosure aims to minimize the absolute value of the error by taking a weighted average of the errors of the individual forecasts.

At point I in the validation period, the error after the linear combination is given by:

Σᵢ₌₁^{N}αᵢε(i,j). (2)

Now, considering the absolute value of the above quantity and taking the average across all the points in the validation period, which is given by:

$$\frac{1}{v} {Σ}_{j = n}^{n + v} \vert {Σ}_{i = 1}^{N} {α}_{i} ε ( i , j ) \vert \qquad ( 3 )$$

We now impose the constraint in (4) to ensure that the weights sum to one.

Σᵢ₌₁^{N}αᵢ=1 (4)

The constraint in (5) ensures that the weights are non-negative.

αᵢ≥0,∀i∈{1,2, . . . N} (5)

The constraints in (4) and (5) are operational constraints to characterize the weights to compute the final point forecast. However, motivated by the inherent idea of soft margin support vector machine (SVM), where a small non-negative deviation is allowed by softening the constraint to handle data that are linearly non-separable [2]. Therefore, the optimization problem is modified from (4) to (5) with softened constraints to generate more robust forecast. The objective function of the proposed optimization framework is:

$$Minimize \frac{1}{v} {\sum }_{j = n}^{n + v} \vert {\sum }_{i = 1}^{N} {α}_{i} ε ( i , j ) \vert \qquad ( 6 )$$

The constraints are

1−δ⁻≤Σᵢ₌₁^{N}αᵢ≤1+δ⁺ for δ⁻,δ⁺>0, (7)

αᵢ≥−γ,∀∈{1,2, . . . N},γ≥0 (8)

The decision variable of the optimization problem is α. After obtaining α from by solving the optimization problem in (6) to (8), the final forecast is computer as

ŷ=Σᵢ₌₁^{N}αᵢyⁱ (9)

The optimization problem presented in (6) to (8) given below is the form of customized optimization based forecast aggregation.

It may be noted that the optimization problem presented in (6) to (8) can easily be extended to support a whole range of scenarios through the objective function. To name a few, it can consider the variance of the error during the validation period or the maximum error or a combination of both.

In order to have a low variance in the error, (6) is to be replaced by (9) given below

$$\frac{1}{v} {\sum }_{j = n}^{n + v} \vert {\sum }_{i = 1}^{N} {α}_{i} ε ( i , j ) \vert + η {var}_{j ∈ \{ n , … n + v \}} ( \vert {\sum }_{i = 1}^{N} {α}_{i} ε ( i , j ) \vert ) \qquad ( 10 )$$

By changing the value of i the preference toward the reduction of variance in the error can be control. A higher value of i will result in more aggressive reduction of variance in the error, for the resulting forecast.

In a more generic setting, the weighted combination of mean absolute percentage error (MAPE), the variance in the error and the maximum value of the error during the validation period can be minimized by setting the objective function of the customized optimization problem as follows

$$\frac{1}{v} {\sum }_{j = n}^{n + v} \vert {\sum }_{i = 1}^{N} {α}_{i} ε ( i , j ) \vert + η {var}_{j ∈ \{ n , … n + v \}} ( \vert {\sum }_{i = 1}^{N} {α}_{i} ε ( i , j ) \vert ) + {μmax}_{j ∈ \{ n , … n + v \}} ( \vert {\sum }_{i = 1}^{N} {α}_{i} ε ( i , j ) \vert ) \qquad ( 11 )$$

In (10) by tuning the value of i and p we can tune our preference between achieving a small MAPE, the variance in the error and the maximum value of the error.

Notably, this idea of optimization to combine a large number of forecasts, as in the proposed customized optimization based forecast aggregation is unique in machine learning practices. The concept of ensemble forecasting is primarily applicable to decision trees where the different trees are combined together with different hyperparameters to produce the final forecast.

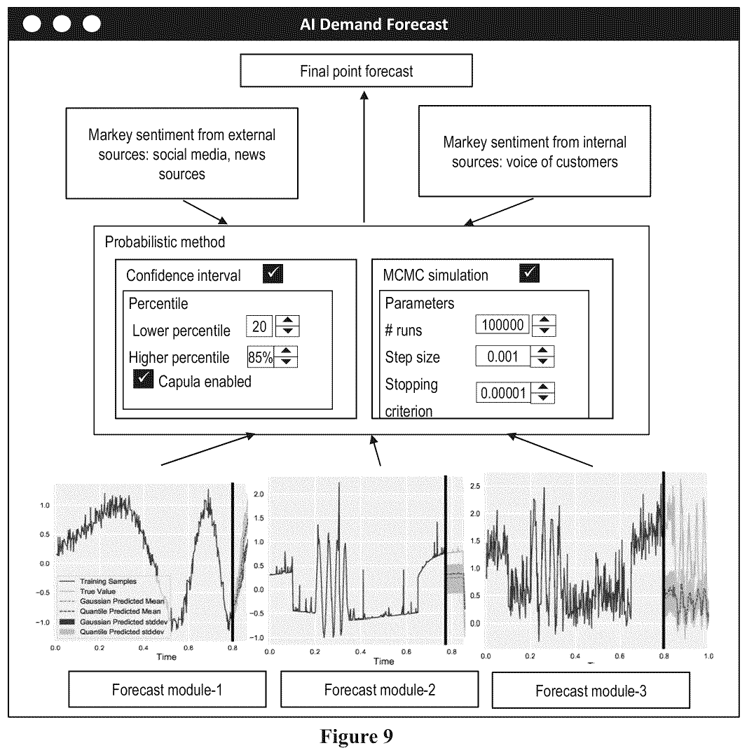

FIG. 9 illustrates a forecast result combination module to combine the forecasts generated by different HECO modules (i.e., forecast and optimization modules) through a probabilistic approach, according to an embodiment of the present disclosure.

The forecast result combination module may be configured to combine forecasts generated through different HECO modules that results from different sets of features, different families of forecast models, and different optimization procedures. This consists of a family of statistical methods to combine multiple forecasts of the same time series together. One such embodiment is to incorporate market sentiment to choose the percentile and/or with simulation with user defined hyperparameters. Thus, the forecast result combination module 120 provides a capability to implement a statistical method on the top of the invented hierarchical ensembling method to combine forecasts from multiple forecast modules. This probabilistic combination increases robustness of the final forecast and also addresses the issue of forecasting highly fluctuating timeseries.

This is the result of SMAPE which is defined as:

$$SMAPE = \frac{100 \%}{n} {\sum }_{t = 1}^{n} \frac{\vert {F}_{t} - {A}_{t} \vert}{( \vert {A}_{t} \vert + \vert {F}_{t} \vert / 2}$$

$$where {A}_{t} is the actual value and {F}_{t} is the forecast value .$$

The average SMAPE is calculated for ˜4000 timeseries that exhibits sparsity. It is seen the performance of a single model (in this case Gradient boost with traditional cross validation) is largely outperformed by HECO with 1000 Gradient boost models where in Customized Optimization module the error is chosen as MAPE.

The proposed method for generating a forecast targets smart factory as one of the key applications and describes a forecast system, a generic model ensembling, a hierarchical ensembling and customization optimization framework, and a probabilistic approach. Further, the disclosure provides solutions for robust model performance in terms of accuracy, stability, reliability for highly fluctuating time series forecast.

Three business scenarios, i.e., use cases of the present disclosure are illustrated herein. For example, the present disclosure may be deployed in hierarchical and sequential manufacturing process. Specifically, manufacturing system is normally composed of a set of hierarchical and sequential processes. It is critical to perform both intra-process and inter-process analysis to identity and predict productivity, quality, and maintenance issues. Further, the present disclosure may be deployed in a modern robot machine system which includes one or more core motors to drive the operation of the manufacturing. Reliability and accurate operation is critical to obtain high productivity and quality. Conditional sensors are equipped to monitor the machine conditions to input to a detection and prediction system. Furthermore, the present disclosure may be deployed in a factory supply-chain process wherein factory analyzes and predicts all supply-demand information of the market, and optimizes inventory-scheduling-production (ISP) management and investment decision.

Additionally, based on implementation of the proposed method for products with real datasets, the results demonstrate that there is a significant improvement in the robustness of the final point forecast in terms of both validation error and forecast (provided by the marketing team) error.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A system for generating a forecast of a timeseries, the system comprising:
an input module configured to receive a set of features comprising data and timeseries to be used by each of a plurality of prediction models for generating the forecast;
a plurality of arbitrary forecast modules, wherein each arbitrary forecast module is configured to generate, using the set of features, a plurality of forecast results based on an ensemble of the plurality of prediction models associated with two or more families of models;
a plurality of optimization modules, each optimization module being configured to optimize the plurality of forecast results associated with a respective forecast module among the plurality of forecast modules, wherein each optimization module is further configured to optimize the plurality of forecast results by minimizing a validation error of an aggregated forecast derived using a plurality of optimization metrices subjected to physical and operational constraints;
a forecast result combination module configured to probabilistically combine the outputs of the plurality of optimization modules; and
an output module that outputs a final forecast based on the combination of the at least two forecast results.

2. The system as claimed in claim 1, wherein each forecast module among the plurality of forecast modules comprises an independent ensemble learning model that combines the plurality of prediction models, and wherein each forecast module is independently configurable.

3. The system as claimed in claim 1, wherein the input module is further configured to:
receive an input associated with a number of the plurality of forecast modules; and
receive one or more inputs associated with the selection of the plurality of prediction models and a plurality of hyperparameters for each forecast module.

4. The system as claimed in claim 1, wherein the input module is further configured to receive an input associated with an arbitrary filtering criterion to filter the plurality of forecast results based on one or more statistical functions.

5. The system as claimed in claim 1, wherein each optimization module has an independent optimization method for each forecast module.

6. The system as claimed in claim 1, wherein the forecast result combination module uses a user-defined statistical method.

7. The system as claimed in claim 1 further comprising:
an output interface configured to display the plurality of forecast results of each forecast module.

8. The system as claimed in claim 1, wherein the plurality of optimization metrics is based on Mean Absolute Percentage Error (MAPE), Mean Absolute Error (MAE), variance, maximum error, higher order moments, and one or more user configurable parameters.

9. The system as claimed in claim 1, wherein the plurality of prediction models includes two or more of a linear regression model, a support vector regression model, a ridge regression model, a lasso regression model, an elastic net model, a Bayesian ridge model, a huber regression model, a KNN model, a gradient boost model, a random forest regression model, a neural network including deep architectures with a range of hyperparameters.

10. A method for generating a forecast of a timeseries, the method comprising:
receiving, by an input module, a set of features comprising data and timeseries to be used by each of a plurality of prediction models for generating the forecast;
generating, by each arbitrary forecast module among a plurality of arbitrary forecast modules, using the set of features, a plurality of forecast results based on an ensemble of the plurality of prediction models;
optimizing, by each optimization module among a plurality of optimization modules, the plurality of forecast results associated with a respective forecast module, wherein the optimization is performed on the plurality of forecast results by minimizing a validation error of an aggregated forecast derived using a plurality of optimization metrices subjected to physical and operational constraints;
probabilistically combining, by a forecast result combination module, the outputs of the plurality of optimization modules; and
outputting, by an output module, a final forecast based on the combination of the at least two forecast results.

11. The method as claimed in claim 10, further comprising:
receiving, by the input module, an input associated with a number of the plurality of forecast modules; and
receiving, by the input module, one or more inputs associated with the selection of the plurality of prediction models and a plurality of hyperparameters for each forecast module.

12. The method as claimed in claim 10, further comprising:
receiving, by the input module, an input associated with a filtering criterion to filter the plurality of forecast results based on one or more statistical functions.

13. The method as claimed in claim 10, wherein the plurality of optimization metrics is based on Mean Absolute Percentage Error (MAPE), Mean Absolute Error (MAE), variance, maximum error, and one or more user configurable parameters to combine the forecasts generated by each prediction model within the same forecast module.

14. The method as claimed in claim 10, wherein the plurality of prediction models includes two or more of a linear regression model, a support vector regression model, a ridge regression model, a lasso regression model, an elastic net model, a Bayesian ridge model, a huber regression model, a KNN model, a gradient boost model, a random forest regression model, and a neural network including deep architectures with a range of hyperparameters.
